(19) United States
(12) Patent Application Publication
(10) Pub. No.: US 2007/0061239 A1
(43) Pub. Date: Mar. 15, 2007

(54) Sports player investment system

(75) Inventor: Kenneth E. DeLine, Avon, CO (US)

Correspondence Address: CR MILES, P.C., 1 OLD TOWN SQUARE, SUITE 200 B, FORT COLLINS, CO, 80524, US

(73) Assignee: CDC Investments, LLLP

(21) Appl. No.: 11/224,751

(22) Filed: Sep. 12, 2005

(51) Int. Cl. G06Q 40/00

(52) U.S. Cl. 705/37; 463/37; 700/91

(57) ABSTRACT

A sports player investment system which prior allocates a fractional ownership in a business entity among a plurality of sports organizations each of which have a plurality of sports players which can also obtain a sports player's fractional ownership allocation within corresponding sport organization's fractional ownership allocation in the business entity.

### I. BACKGROUND

A sports player investment system which prior allocates a fractional ownership in a business entity among a plurality of sports organizations each of which have a plurality of sports players which can also obtain a sports player's fractional ownership allocation within corresponding sport organization's fractional ownership allocation in the business entity.

Through association with a regional sports team or a regional sports player the community can build a regional asset in the brand identity of a regional sports team or in the brand identity of the regional sports player, or both. The brand identity in the regional sports team or the brand identity in the regional sports player adds greater value to the entire region. Not just the downtown region, but also the suburban regions, as sports fans in the suburban regions feel there's a reason to want to be part of the downtown region. The collective consciousness of sports fans loyal to a regional sports team can establish a vast regional market for goods and services which can extend well beyond the political boundaries of the city or state in which the regional sports team and regional sports players reside. As an example, the Colorado Rockies® baseball team located in Denver, Colo. casts a large regional economic shadow which even generates substantial revenues from certain surrounding states which do not have a Major League baseball team to compete for the loyalty of Colorado Rockies sports fans.

This regional brand identity in the regional sports team or the brand identity in the individual regional sports player can be important because the brand acts to build interest in the survivability of the regional community, and brings sports fans together for the sporting events and to engage in other activities which further develops the regional community and promotes regional businesses. Regional branding also enables regional sports teams and regional sports players to manage the public perception of their common and individual sports business in the regional community. By promoting a unique niche that sets the sports team or the sports player apart from other sports teams and sports players, sports fans are better able to distinguish one sports team or one sports player from another. These distinctions make it easier for a prospective fan to identify a sports team or sports player from the start. When a prospective fan can readily identify with the sports team or the sports player, it is easier for the sports team or for the sports player to achieve sports fan satisfaction.

National sports organizations such as Major League Baseball maintain a unique, controlling relationship over regional sports teams and regional sports players, including most aspects of the corresponding minor league teams. This is due in large part to a 1922 United States Supreme Court ruling in Federal Baseball Club v. National League which declared baseball is not considered interstate commerce (and therefore not subject to federal antitrust law), despite baseball's own references to itself as an “industry” rather than a “sport.”

Major League Baseball (“MLB”), as but one example of a national sports organization, is governed by a Major League Constitution, an agreement that has undergone several incarnations since 1920, with the most recent revisions being made in 2001. Under the Major League Constitution, Major League Baseball, by direction of its Commissioner, hires and maintains the sport's umpiring crews, and negotiates marketing, labor, and television contracts. The ‘closed shop’ aspect of MLB effectively prevents the yearly promotion and demotion of teams into and out of the Major League by virtue of their performance. Over the years a plurality of national sports organizations have been established each of which govern the conduct of a plurality of regional sports teams, each regional sports team having plurality of regional sports players which typically reside at the geographic nexus of the corresponding regional sports team.

Understandably, the regional sports player can be the most significant revenue driver available to the regional sports team and the national sports organization. While in general, the national sports organization or the regional sports team cannot force sports players to provide services to the sports team, the legal status of the national sports organization can prohibit or restrict the free transfer of contracted regional sports players between regional sports teams. This organization in the sports industry allows national sports organizations to invest in young sports players that once discovered, nourished and developed may make their way on the playing squad. At a later stage the regional sports player can be transferred to anther regional sports team at a premium. Players who don't make the grade at the first regional sports team can never-the-less be sold off at a profit to other regional sports teams. As a result, there is an incentive which reaches beyond increasing the overall success of the regional sports team to trade regional sports players between regional sports teams. See Accounting For Human Capital When Labor Mobility Is Restricted, Eli Amir, Tel Aviv University and Gilad Livne, London Business School (2000).

However, the economic incentives to trade regional sports players between regional sports teams coupled with the limited capacity in the sports player to achieve compulsory retention in a single regional sports team can result a transient residence which limits use of the regional sports players brand identity by the national sports organization, the regional sports team, and the regional sports player which can limit the regional sports player's investment to portable assets. As but one non-limiting example, sports restaurants which are owned by or depend upon the brand identity of a regional sports player may be difficult to maintain once the regional sports player is traded to another competitive regional sports team.

Conversely, non-regional sports players such as boxers, tennis players, race car drivers, golfers, or the like, generally rely upon developing a national or even international brand identity in which the collective consciousness of sports fans can identify. However, it can be difficult in non-regional sports competition to achieve sufficient exposure in the media to develop the necessary recognition among sports fans to build a national or international brand in a non-region sports player. Additionally, an impediment to building national or international brand identity appears to be that no mechanism is available to the non-regional sports player to build regional branding power and regional fan recognition to aid in developing national or international brand recognition in the non-regional sports player.

While many investment paradigms are known, including those described in U.S. Pat. Nos. 5,193,056; 6,338,047; 6,606,606; 6,622,130; 6,684,190; 6,778,968; and 6,795,811, there is apparently no sports player investment paradigm specifically tailored to for transient residence regional sports players that play for regional sports teams (such as those governed by national sports organizations) which allows the regional sports player to easily invest in and transfer basis in non-portable regional assets which can exploit the brand identity of the national sports organization, the regional sports team, or the sports player even in view of transient residence.

The instant sports player investment system addresses the limitation of transient residence of sports players by providing a sports player investment system which prior allocates ownership in a business entity among a plurality of sports organizations having a plurality of sports players each of which can obtain a prior allocated fractional ownership in the business entity.

### II. SUMMARY OF THE INVENTION

Accordingly, a broad object of the invention can be to provide sports player investment system which prior allocates a fractional ownership in a business entity among a plurality of sports organizations each of which have a plurality of sports players which can also obtain a sports player's fractional ownership allocation within corresponding sport organization's fractional ownership allocation in the business entity.

A second broad object of the invention can be to establish a business entity structure which includes a national business entity (or national holding company) which diversifies investment among non-regional sports by establishing a plurality of sports organization's fractional ownership allocations each of which can be allocated to a sports organization in which a plurality of non-regional sports players participate.

A third broad object of the invention can be to diversify investment in the above-described national business entity among non-regional sports players by establishing a plurality of non-regional sports player's fractional ownership allocations within each of the above-described plurality of sports organization's fractional ownership allocations in the national business entity

A fourth broad object of the invention can be balance investment among a the plurality of non-regional sports and among a plurality of non-regional sports players by limiting investment to the prior allocated sports organization's fractional ownership allocation and to the prior allocated non-regional sports player's fractional ownership allocation.

A fifth broad object of the invention can be to establish a business entity structure which includes a plurality of regional operational business entities (or regional operating companies) each of which diversify investment among regional sports by establishing a plurality of sports organization's fractional ownership allocations each of which correspond to a sports organization in which a plurality regional sports players participate.

A sixth broad object of the invention can be can be to diversify investment in each of the above-described regional operational business entities among regional sports players by establishing a plurality of regional sports player's fractional ownership allocations within each of the above-described plurality of regional sports organization's fractional ownership allocations in the regional operational business entity.

A seventh broad object of the invention can be balance investment among the plurality of regional sports and among the plurality of regional sports players by limiting investment to the prior allocated regional sports organization's fractional ownership allocation and to the prior allocated regional sports player's fractional ownership allocation.

An eighth broad object of the invention can be to make each sports player's investment in a first regional operational business entity in a first region portable to a second region whether or not a second regional operation business entity has a location in the second region.

Naturally, further objects of the invention are disclosed throughout other areas of the specification, drawings, photographs, and claims.

### III. A BRIEF DESCRIPTION OF THE DRAWINGS

FIG. 1 is a block diagram representing the structure of a plurality of business entities of a particular embodiment of the invention.

FIG. 2 is a block diagram representing the allocation of ownership between the plurality of business entities and a plurality of sports organizations and sports players of a particular embodiment of the invention.

FIG. 3 is a block diagram representing a particular method of purchasing and issuing shares in a regional operational company of a particular embodiment of the invention.

FIG. 4 is a block diagram representing a particular method of establishing and transferring a fractional ownership of a player within the structure of the plurality of business entities shown by FIG. 1.

### IV. DETAILED DESCRIPTION OF THE PREFERRED EMBODIMENTS

A sports player investment system which prior allocates ownership in a business entity among a plurality of sports organizations having a plurality of sports players each of which can obtain a prior allocated fractional ownership in the business entity.

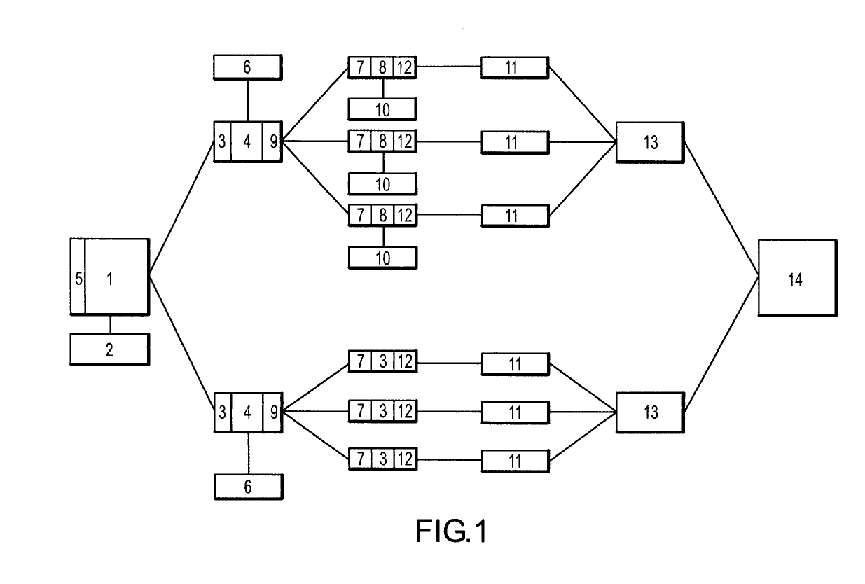

First referring primarily to FIG. 1, a particular embodiment of the invention can include business entity structure which provides a national business entity (or national holding company) (1). The national business entity can comprise a business entity owned in common by a plurality of national business entity share holders (2) which controls the interest in the securities of other companies, or can be a parent corporation that owns enough voting stock in another corporation to control its board of directors (and, therefore, controls its policies and management). In a preferred embodiment of the invention, the national business entity (1) owns all or a controlling portion of the regional common shares of stock (3) in at least one or a plurality of regional operational business entities (4) and has the capacity to issue national preferred shares of stock (or national preferred shares)(5). As to certain embodiments of the invention, the national business entity (1) can perform the function of both the national business entity (1) and the regional operational business entities (4).

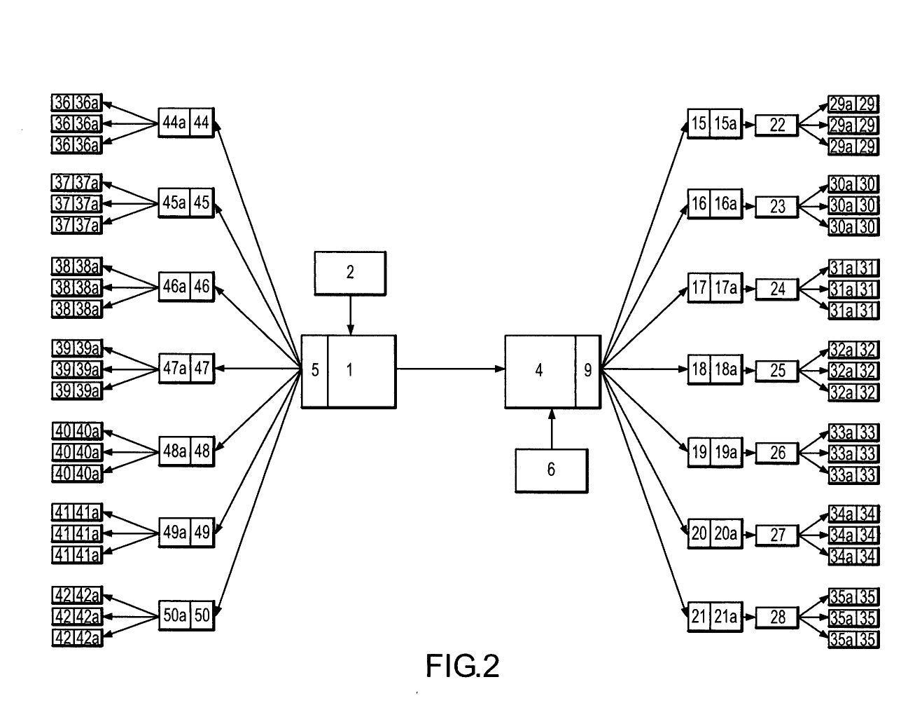

Each regional operational business entity (or regional operating company)(4) can comprise a business entity owned in common by a plurality of regional operational business entity shareholders (6)(see FIG. 2) which owns all or a controlling portion of the local shares of stock (or local shares)(7) of each of a plurality of local operational business entities (8) within a geographic region regardless of the number or kind of the local operational business entities (8) and has the capacity to issue regional preferred shares of stock (9).

Each local operational business entity (or local operating company) (8) can comprise a business entity which can be independently owned by a plurality of local sports players (10) (as further described below) which operates at a location within the region of the corresponding regional operational business entity (4) to provide goods or services. While the local operational business entity (8) can be a restaurant business entity where meals, or refreshments, or both, are served, such as the sports theme restaurant described by U.S. patent application Ser. No. 11/173719, hereby incorporated by reference in the entirety herein, and which may further include controlled content as described by U.S. patent application Ser. No. 11/110,481, hereby incorporated by reference in the entirety herein, it is not intended that these particular restaurant business entity examples limit the numerous and wide variety of local operational business entities (8) both restaurant business entities or non-restaurant business entities encompassed by the invention.

Again referring to FIG. 1, the sports player investment invention can further include a local real estate business entity (11) which can comprise a business entity which manages the real property (12) of the local operational business entity (8). As to certain embodiments of the invention can further include a regional real estate business entity (13) which can comprise a business entity which in part owns a plurality of local real estate business entities (11). The plurality of regional real estate business entities (13) can in part be owned and overseen by a national real estate business entity (14).

Now referring to FIG. 2, each regional operational business entity (4)(or the national business entity (1) as to those embodiments of the invention which the national business entity (1) also performs the functions of the regional operational business entity) owned by a plurality of regional business entity share holders (6) has the capacity to subscribe and issue preferred shares of stock (or regional preferred shares)(9). The regional operational business entity (4) establishes for each of a plurality of regional sports organizations (15, 16, 17, 18, 19, 20, 21) a sport's organization fractional ownership allocation (15a, 16a, 17a, 18a, 19a, 20a, 21a) in the regional preferred shares (9) of the regional operational business entity (4) to generate a desired balanced representation of various regional sports organizations (15, 16, 17, 18, 19, 20, 21) in the regional preferred shares (9) of the regional operational business entity (4).

As to certain preferred embodiments of the sports player investment invention, the sport's organization fractional ownership allocation (15a, 16a, 17a, 18a, 19a, 20a, 21a) can be established prior to formation of, operation of, or prior to subscription of, any regional preferred shares in the regional operational business entity (4). As to these embodiments of the invention, the regional business entity (4) (or the national business entity(1)) affirmatively acts to prior allocate the fractional ownership interests in the regional business entity (4) to establish a balance of ownership in the regional business interest among a plurality of regional sports organizations (15, 16, 17, 18, 19, 20, 21) which is not merely reflexive to demand in regional preferred shares (9) but which acts to limit the fractional ownership in the regional operational business entity (4) as any one of the plurality of regional sports organizations (15, 16, 17, 18, 19, 20, 21) to the extent of the regional sports organization's fractional ownership allocation (15a, 16a, 17a, 18a, 19a, 20a, 21a) in the regional preferred shares (9) of the regional operational business entity (4).

A regional sports organization (15, 16, 17, 18, 19, 20, 21) can comprise a sports business entity which governs the conduct of a plurality of member regional sports teams (22, 23, 24, 25, 26, 27, 28) each correspondingly having a plurality of regional sports players (29, 30, 31, 32, 33, 34, 35). Examples of regional sports organizations (22, 23, 24, 25, 26, 27, 28) which govern a plurality of regional sports teams (22, 23, 24, 25, 26, 27, 28) include, without limitation, Major League Baseball, National Basketball Association, National Football League, National Hockey League, Canadian Football League, Arena Football League, Major League Soccer, National Lacrosse League, Women's National Basketball Association, or the like; however, this illustrative list is not intended to limit the numerous and wide variety of regional sports organizations (15, 16, 17, 18, 19, 20, 21) which can obtain a sports organization's fractional ownership allocation (15a, 16a, 17a, 18a, 19a, 20a, 21a) of the preferred shares (9) of the regional operational business entity (4). Similarly, while FIG. 2 shows only seven different regional sports organization's fractional ownership allocations (15a, 16a, 17a, 18a, 19a, 20a, 21a) in the preferred shares (9) of the regional business entity (4), this is not intended to be limiting with respect to the number or kind of regional sports organizations or regional sports teams among which the preferred shares (9) of the regional operational business entity (4) can be prior allocated based upon a variety of factors, such as, the presence or absence of a regional sports team (22, 23, 24, 25, 26, 27, 28) of the regional sports organization (15, 16, 17, 18, 19, 20, 21) in the particular region in which the regional operational business entity (4) is located; the numerosity and loyalty of the sports fans in the particular region of the regional operational business entity (4), or the like. It should further be understood that the term regional sports team can include without limitation regional professional sports teams, regional university or college teams, regional semi-professional sports teams, regional minor league sports teams, regional amateur teams, or other organizational types of regional sports teams.

Again referring to FIG. 2, the sports player investment invention can further establish for each of a plurality of regional sports players (29, 30, 31, 32, 33, 34, 35) within each regional sports team (22, 23, 24, 25, 26, 27, 28) of a regional sports organization (15, 16, 17, 18, 19, 20, 21) a regional sports player's fractional ownership allocation (29a, 30a, 31a, 32a, 33a, 34a, 35a) of the regional sports organization's fractional ownership allocation (15a, 16a, 17a, 18a, 19a, 20a, 21a) of the preferred shares (9) of the regional operational business entity (4).

As such, a plurality of regional sports players (29, 30, 31, 32, 33, 34, 35) encompassed by the invention above-described can comprise a person whether male or female that plays for a regional sports team, and includes without limitation a baseball player, basketball player, a football player, a hockey player, a soccer player, or the like. Importantly, while a number of factors can be considered in establishing the sports player's fractional ownership allocation (29a, 30a, 31a, 32a, 33a, 34a, 35a) , as above discussed, the regional operational business entity (4) in accordance with the invention establishes the fractional ownership that can be allocated to each sports player, prior to operation of the regional operational business entity (4), or prior to any subscription or issue of the preferred shares (9), of the regional operational business entity (4). This aspect of the sports players investment invention provides an advantage of allowing investment by and maintaining balance of ownership between a numerous and wide variety of regional sports players (29, 30, 31, 32, 33, 34, 35) in the regional operational business entity (4).

Once the operation of the regional operational business entity (4) has begun, the plurality of regional sports organization's fractional ownership allocations (15a, 16a, 17a, 18a, 19a, 20a, 21a) between different sports organizations (15, 16, 17, 18, 19, 20, 21) can be maintained ensuring that no regional sports organization (15, 16, 17, 18, 19, 20, 21) or regional sports team (22, 23, 24, 25, 26, 27, 28) or regional sports player (29, 30, 31, 32, 33, 34, 35) can further invest in the regional operational business entity (4), if the preferred shares (9) representing the entire fractional ownership allocation for the particular regional sports organization (15, 16, 17, 18, 19, 20, 21), regional sports team (22, 23, 24, 25, 26, 27, 28), or regional sports player (29, 30, 31, 32, 33, 34, 35) have been already been subscribed. Additionally, as to those regional sports organizations (15, 16, 17, 18, 19, 20, 21) in which the entire fractional ownership allocation has already been subscribed additional sports players in the sport governed by the sports organization cannot invest in the regional operational business entity (4) until a sports player already vested in the regional operational business entity (4) divests regional preferred shares (9), freeing up some of the corresponding sports organization's fractional ownership allocation (15a, 16a, 17a, 18a, 19a, 20a, 21a), or additional regional preferred shares (9) are generated in the sports organization fractional ownership allocation (15a, 16a, 17a, 18a, 19a, 20a, 21a) due to establishment of additional local operational business entities (8) within the region in which the corresponding regional operational business entity (4) is located.

Again referring primarily to FIG. 2, as to other embodiments of the invention, a sports player can be an individual sports player (whether professional semi-professional, or amateur) that participates in a sport such as boxing, automobile racing, golf, tennis, rodeo, or the like, which may not generate a regional brand identity in the non-regional sports organization or non-regional sports player based on the collective consciousness or loyalty of sports fans within a limited geographic region.

A plurality of non-regional sports players (36, 37, 38, 39, 40, 41, 42) can be governed or participate in a corresponding non-regional sports organization (44, 45, 46, 47, 48, 49, 50) including, without limitation, the National Association For Stock Car Auto Racing, the International Tennis Federation, the Association of Tennis Professionals, the Professional Golfers' Association, the World Boxing Association, or the like. While FIG. 2 shows only seven different non-regional sports organizations (44, 45,.46, 47, 48, 49, 50) in which the national preferred shares (5) of the national business entity (1) can be prior allocated, this illustrative example is not intended to limit the number or kind of sports organizations among which a portion of the national preferred shares (5) of the national business entity (1) can be prior allocated.

As to these embodiments of the sports player investment invention the national business entity (1) can establish a non-regional sports organization's fractional ownership allocation (44a, 45a, 46a, 47a, 48a, 49a, 50a) in the national preferred shares (5) of the national business entity (1) for each of a plurality of non-regional sports organizations (44, 45, 46, 47, 48, 49, 50). Each non-regional sports organization's fractional ownership allocation (44a, 45a, 46a, 47a, 48a, 49a, 50a) established can be further subdivided into a plurality of non-regional sports player's fractional ownership allocations (36a, 37a, 38a, 39a, 40a, 41a, 42a). The prior allocation of the fractional ownership interests in the plurality of non-regional sports organizations (44, 45, 46, 47, 48, 49, 50) and in the plurality of non-regional sports players (36, 37, 38, 39, 40, 41, 42) can operate to include a numerous and wide variety of non-regional sports players (36, 37, 38, 39, 40, 41, 42) and non-regional sports organizations (44, 45, 46, 47, 48, 49, 50) as investors in the national preferred shares (5) of the national business entity (1).

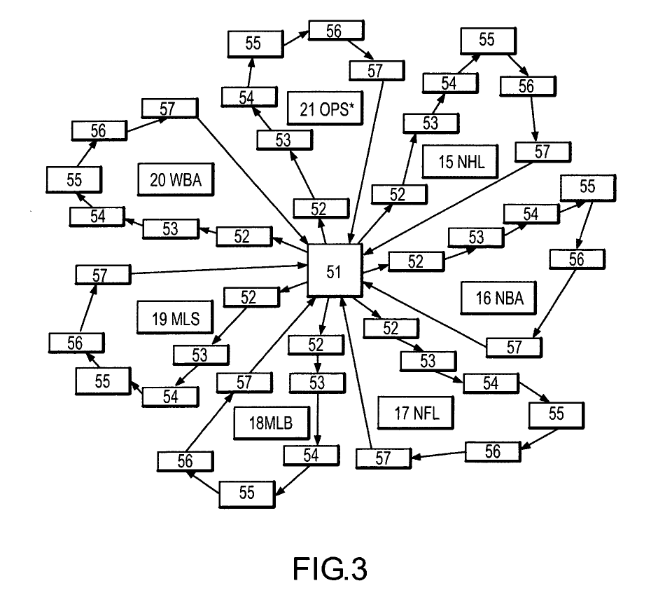

Now referring primarily to FIG. 3, a particular method of investment by regional sports players (29, 30, 31, 32, 33, 34, 35) is shown. The method comprises the step of forming a regional operational business entity (4)(step 51)(which can as to certain other embodiments of the invention can interact with a national business entity (1) which can own all or a controlling portion of the regional common shares of stock (9) in a plurality of regional operational business entities (4), as shown by FIGS. 1 and 2) and which can further include the step of prior allocating to each of a plurality of regional sports organizations (15, 16, 17, 18, 19, 20, 21) a sports organization's fractional ownership allocation (15a, 16a, 17a, 18a, 19a, 20a, 21a) in the preferred shares (9)(step 52) of the regional operational business entity (4) formed at a location in a region. While the FIG. 3 shows the method of sports player investment for only seven regional sports organizations (15, 16, 17, 18, 19, 20, 21) in which a regional sports organization fraction ownership allocation (15a, 16a, 17a, 18a, 19a, 20a, 21a) can be prior allocated, it is not intended that the sports player investment invention limit the number of regional sports organizations (15, 16, 17, 18, 19, 20, 21) to which the regional preferred shares (9) in the regional operational business entity (4) can be prior allocated and any desired number (whether lesser or greater) of regional sports organizations (15, 16, 17, 18, 19, 20, 21) can be included in the sports players investment method.

The sports player investment invention can include the further step of prior allocating to each a of plurality of regional sports players (29, 30, 31, 32, 33, 34, 35) a regional sports player's fractional ownership allocation (29a, 30a, 31a, 32a, 33a, 34a, 35a) of the preferred regional shares (9) allocated to the corresponding sports organization (15, 16, 17, 18, 19, 20, 21) (step 53).

After the regional operational business entity (2) begins operation, the step of recruiting regional sports players (54) to invest can commence. Recruited regional sports players (29, 30, 31, 32, 33, 34, 35) can take the further step of purchasing preferred shares (9) in the regional operational business entity (4)(step 55) and the regional operational business entity (4) can take the subsequent step of issuing the preferred shares (9)(step 56) to the regional sports players (29, 30, 31, 32, 33, 34, 35) which does not exceed the regional sports player's fractional ownership allocation (29a, 30a, 31a, 32a, 33a, 34a, 35a) within the sports organization's fractional ownership allocation (15a, 16a, 17a, 18a, 19a, 20a, 21a). Each regional sports player (29, 30, 31, 32, 33, 34, 35) who purchases preferred shares (9)(step 54) and to whom preferred shares (9) are issued (step 55) can take the further step of transferring the preferred shares (9) back to the regional operational business entity (4) (step 57) as further discussed below.

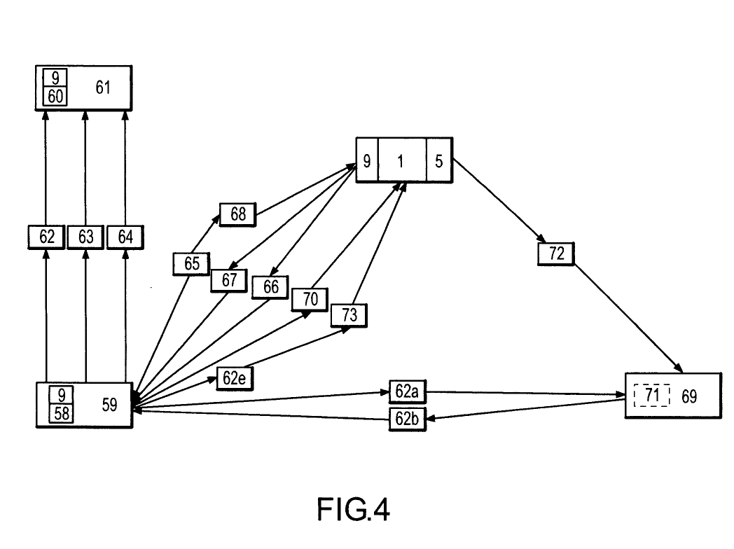

Now referring to FIGS. 3 and 4, the sports player investment invention can further include the elements and steps shown by which a regional sports player (29, 30, 31, 32, 33, 34, 35) can divest preferred shares (9) in a first regional operational business entity (58) having a location in a first region (59) and utilize the basis in the preferred shares (9) to acquire preferred shares (9) in a second regional operational business entity (60) in a second region (61).

In a preferred embodiment of the invention, a first regional sports player (62) having obtained preferred shares (9) in the first regional operational business entity (58) which represent, in part or in whole, but does not exceed a sports player's fractional ownership allocation (29a, 30a, 31a, 32a, 33a, 34a, 35a) of the corresponding sports organization's fractional ownership allocation (15a, 16a, 17a, 18a, 19a, 20a, 21a) may transfer from the first region (59) to the second region (61) in which a second regional operational business entity (60) is located. The preferred shares (9) obtained by the first sports player (62) from the first regional operational business entity (58) located in a first region (59) can be transferred (63) from the first regional operational business entity (58) to the second regional operational business entity (60) located in the second region (61). The first regional operational business entity (58) pays the second regional operational business entity (60) a regional preferred share basis amount (64) in the preferred shares (9) transferred (63) from the first regional operational business entity (58) in the first region (59) to the second regional operational business entity (60) in the second region (61).

Transferring (63) the regional preferred shares (9) of the first regional sports player (62) to the second regional operational business entity (60) generates in the first regional operational business entity (58) a sports player's fractional ownership allocation (29a, 30a, 31a, 32a, 33a, 34a, 35a) within the corresponding sports organization's fractional ownership allocation (15a, 16a, 17a, 18a, 19a, 20a, 21a) which can be purchased by a second regional sports player (65) in the first regional operational business entity (58) in the first region (59). Upon purchase of the available sports player's fractional ownership allocation (29a, 30a, 31a, 32a, 33a, 34a, 35a) of regional preferred shares (9) in the first regional operational business entity (58), whether in part or in whole, any differential amount (66) between the regional preferred share basis amount (64) paid to the second regional operational business entity (60) by the first regional operational business entity (58) and an amount paid by the second regional sports players (65) in the first region for an equivalent fractional ownership in the first regional operational company (58) can be paid by the national business entity (1) to the first regional operational company (58). Preferred shares (9) equivalent to the differential amount (66) can be issued to the national business entity (1)(step 67). When regional preferred shares (9) of the first regional operational business entity (58) are held by the national business entity (1) these regional preferred shares (9) in the national business entity (1) can be purchased by the second regional sports player (65)(step 68) first and then additional regional preferred shares (9) can be purchased by the second regional sports player (65) from the first regional operational business entity (58).

Again referring to FIGS. 3 and 4, the sports player investment invention can further include the elements and steps shown by which a first regional sports player (62) having obtained preferred shares (9) in a first regional operational business entity (58) located in a first region (59) who relocates to a non-operational region (69) which does not have a regional operational business entity can divest regional preferred shares (9) in the first regional operational business entity (58) and utilize the basis in the preferred shares (9) to acquire national preferred shares (5) in the national business entity (1).

In another preferred embodiment of the invention, a first regional sports player (62a) having obtained preferred shares (9) in a first regional operational business entity (58) which represent, in part or in whole, (but does not exceed) a sports player's fractional ownership allocation (29a, 30a, 31a, 32a, 33a, 34a, 35a) of the corresponding sports organization's fractional ownership allocation (15a, 16a, 17a, 18a, 19a, 20a, 21a) may be transferred from a first region (59) to a non-operational region (69) in which no regional operational business entity is located. The preferred shares (9) obtained by the first sports player (62a) from the first regional operational business entity (58) located in a first region (59) can be transferred (step 70) along with the preferred regional share basis amount to the national business entity (1). Subsequently, if a regional operational business (71)(shown by hash mark lines) can be established in the non-operational region (69), the regional preferred shares (9) and preferred share basis prior transferred to the national business entity (1) can be transferred (step 72) to the newly established regional operational company (71).

Again referring to FIGS. 3 and 4, the sports player investment invention can further include the elements and steps shown by which a regional sports player (62b) who relocates from a non-operational region (69) which does not have a regional operational business entity can obtain preferred shares (9) in the first regional operational business entity (58) when a sports player's fractional ownership allocation (29a, 30a, 31a, 32a, 33a, 34a, 35a) in the first regional operational business entity (58) becomes available for purchase.

Now referring primarily to FIG. 4, the sports player investment invention can further include the elements and steps shown by which regional preferred shares (9) held by a first regional sports player (62c) along with the regional preferred share basis in a first regional operational business entity (58) can be transferred (step 73) to the national business entity (1) if the first regional business entity (58) terminates business. The regional preferred share basis in the preferred shares (9) transferred to the national business entity (1) can be exchanged for an equivalent amount of national preferred stock (5) in the national business entity (1).

As can be easily understood from the foregoing, the basic concepts of the present invention may be embodied in a variety of ways. The invention involves numerous and varied embodiments of a sports player investment system and methods of making and using the sports player investment.

As such, the particular embodiments or elements of the invention disclosed by the description or shown in the figures accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of an “investment” should be understood to encompass disclosure of the act of “investing”—whether explicitly discussed or not—and, conversely, were there effectively disclosure of the act of “investing”, such a disclosure should be understood to encompass disclosure of an “investment” and even a “means for investing.” Such alternative terms for each element or step are to be understood to be explicitly included in the description.

In addition, as to each term used it should be understood that unless its utilization in this application is inconsistent with such interpretation, common dictionary definitions should be understood to included in the description for each term as contained in the Random House Webster's Unabridged Dictionary, second edition, each definition hereby incorporated by reference.

Thus, the applicant(s) should be understood to claim at least: i) each of the sports players investment systems herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The claims set forth in this specification are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

The claims set forth below are intended describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1-26. (canceled)

27. A method of sports player investment, comprising the steps of:
a. forming a business entity;
b. allocating to each of a plurality of sports organizations a sports organization's fractional ownership allocation in said business entity;
c. establishing a fractional ownership in said business entity capable of purchase by at least one of said plurality of sports organizations which does not exceed said sports organization's fractional ownership allocation; and
d. maintaining a plurality of shares in said business entity capable of issue to said at least one of said plurality of sports organizations which represent said fractional owner ship in said business entity which does not exceed said sports organization's fractional ownership allocation in said business entity.

28. A method of sports player investment as described in claim 27, wherein said step of allocating to each of a plurality of sports organizations a sports organization's fractional ownership allocation in said business entity comprises the step of allocating to each of a plurality of sports organizations a sports organization's fractional ownership allocation in said business entity prior to the operation of said business entity.

29. A method of sports player investment as described in claim 28, further comprising the step of purchasing said fractional ownership in said business entity by at least one of said plurality of sports organizations which does not exceed said sports organization's fractional ownership allocation in said business entity.

30. A method of sports player investment as described in claim 29, further comprising the step of issuing a plurality of shares to said at least one of said plurality of said sports organizations which represent said fractional ownership in said business entity which does not exceed said sports organization's fractional ownership allocation in said business entity.

31. A method of sports player investment as described in claim 30, further comprising the step ofallocating to each of a plurality of sports players in each of said plurality of sports organizations a sports player's fractional ownership allocation of said sports organization's fractional ownership allocation.

32. A method of sports player investment as described in claim 31, wherein said step of allocating to each of a plurality of sports players in each of said plurality of sports organizations a sports player's fractional ownership allocation of said sports organization's fractional ownership allocation comprises the step of allocating to each of a plurality of sports players a sports player's fractional ownership allocation in said business entity prior to the operation of said business entity.

33. A method of sports player investment as described in claim 32, further comprising the steps of:
a. purchasing said fractional ownership in said business entity by at least one of said plurality of sports players in at least one of said sports organizations which does not exceed said sports player's fractional ownership allocation of said sports organization's fractional ownership allocation; and
b. issuing a plurality of shares to said at least one of said plurality of sports players in said at least one of said sports organizations which represent said fractional ownership in said business entity which does not exceed said sports player's fractional ownership allocation obtainable in said sports organization's fractional ownership allocation in said business entity.

34. A method of sports player investment as described in claim 33, wherein said step of forming said business entity comprises the step of forming a national business and a plurality of regional operational business entities, and wherein said plurality of sports organizations comprise a plurality of non-regional sports organizations and a plurality of regional sports organizations, and wherein said plurality of sports players comprise a plurality of non-regional sports players and a plurality of regional sports players.

35. A method of sports player investment as described in claim 34, wherein establishing a fractional ownership in said business entity capable of purchase by at least one of said plurality of sports organizations which does not exceed said sports organization's fractional ownership allocation comprises the step of establishing a fractional ownership in said national business entity capable of purchase by at least one of said plurality of non-regional sports organizations which does not exceed said sports organization's fractional ownership allocation in said national business entity.

36. A method of sports player investment as described in claim 35, wherein said step of maintaining a plurality of shares in said business entity capable of issue to said at least one of said plurality of sports organizations which represent said fractional ownership in said business entity which does not exceed said sports organization's fractional ownership allocation in said business entity comprises the step of maintaining a plurality of national preferred shares in said national business entity capable of issue to at least one of a plurality of non-regional sports organizations which represent said fractional ownership in said national business entity which does not exceed said sports organization's fractional ownership allocation in said national business entity.

37. A method of sports player investment as described in claim 36, further comprising the steps of:
a. establishing a plurality of common shares in each of said plurality of regional operational business entities, and
b. owning all of said plurality of shares in each of said plurality of regional operational business entities by said national business entity.

38. A method of sports player investment as described in claim 37, wherein said step of establishing a fractional ownership in said business entity capable of purchase by at least one of said plurality of sports organizations which does not exceed said sports organization's fractional ownership allocation comprises the step of establishing a fractional ownership in said regional operational business entity capable of purchase by at least one of said plurality of regional sports organizations which does not exceed a regional sports organization's fractional ownership allocation in said regional operational business entity.

39. A method of sports player investment as described in claim 38, wherein said step of maintaining a plurality of shares in said business entity capable of issue to said at least one of said plurality of sports organizations which represent said fractional ownership in said business entity which does not exceed said sports organization's fractional ownership allocation in said business entity comprises the step of maintaining a plurality of regional preferred shares in said regional operational business entity capable of issue to at least one of a plurality of regional sports organizations which represent said fractional ownership in said regional operational business entity which does not exceed said regional sports organization's fractional ownership allocation in said regional operational business entity.

40. A method of sports player investment as described in claim 39, wherein said step of purchasing said fractional ownership in said business entity by at least one of said plurality of sports players in at least one of said sports organizations which does not exceed said sports player's fractional ownership allocation of said sports organization's fractional ownership allocation comprises the step of purchasing said fractional ownership in said business entity by at least one of a plurality of regional sports players in at least one of said regional sports organizations which does not exceed said regional sports player's fractional ownership allocation of said sports organization's fractional ownership allocation in said regional operational business entity.

41. A method of sports player investment as described in claim 40, wherein said step of issuing a plurality of shares to said at least one of said plurality of sports players in said at least one of said sports organizations which represent said fractional ownership in said business entity which does not exceed said sports player's fractional ownership allocation obtainable in said sports organization's fractional ownership allocation in said business entity comprises the step of issuing a plurality of regional preferred shares to said at least one of said plurality of regional sports players in said at least one of said regional sports organizations which represent said fractional ownership in said regional operational business entity which does not exceed said regional sports player's fractional ownership allocation obtainable in said regional sports organization's fractional ownership allocation in said regional operational business entity.

42. A method of sports player investment as described in claim 41, further comprising the step of excluding purchase of said plurality of regional preferred shares of said at least one regional operational business entity by said at least one of said plurality of sports players to the extent such purchase of said plurality of regional preferred shares in said at least one regional operational business entity exceeds said regional sports player's total fractional ownership obtainable in said regional sports organization's fractional ownership allocation in said regional operational business entity.

43. A method of sports player investment as described in claim 42, further comprising the step of establishing a first regional operational business entity located in a first region and a second regional operational business entity located in a second region, and wherein step of purchasing said fractional ownership in said at least one regional operational business entity by said at least one of said plurality of regional sports players in at least one of said regional sports organizations which does not exceed said regional sports player's fractional ownership allocation obtainable in said regional sports organization's total fractional ownership allocation in said regional business entity comprises purchasing said fractional ownership in said first regional operational business entity located in said first region by said at least one of said plurality of regional sports players in at least one of said regional sports organizations which does not exceed said sports player's fractional ownership allocation obtainable in said regional sports organization's total fractional ownership in said business entity.

44. A method of sports player investment as described in claim 43, further comprising the step of transferring said at least one of said plurality of regional sports players in at least one of said plurality of regional sports organizations from said first region to said second region.

45. A method of sports player investment as described in claim 44, further comprising the step of transferring said plurality of regional preferred shares of said first regional operational business entity issued to said at least one of said plurality of regional sports players in at least one of said plurality of regional sports organizations to said second regional operational business entity.

46. A method of sports player investment as described in claim 45, further comprising the step of paying a regional preferred share basis amount in said plurality of preferred shares of said first regional operational business entity transferred to said second regional operational business entity by said first regional operational business entity to said second regional operational business entity.

47. A method of sports player investment as described in claim 46, further comprising the step of paying a regional differential amount between said regional preferred share basis amount in said plurality of regional preferred shares of said first regional operational business entity transferred to said second regional operational business entity and an regional preferred share amount paid by another of said plurality of regional sports players in at least one of said regional sports organizations to purchase an equivalent fractional ownership in said first regional operational business entity by said national business entity to said first regional operational business entity.

48. A method of sports player investment as described in claim 47, the step of transferring to said national business entity an amount of regional preferred shares in said first regional operational business entity equivalent to said regional differential amount paid by said national business entity to said first regional operational business entity.

49. A method of sports player investment as described in claim 42, wherein said step of forming a national business and a plurality of regional operational business entities comprises the step of forming a business entity having a national business entity and a first regional operational business entity located in a first region, and wherein said step of purchasing said fractional ownership in said at least one regional operational business entity by said at least one of said plurality of regional sports players in at least one of said regional sports organizations which does not exceed said regional sports player's fractional ownership allocation obtainable in said regional sports organization's fractional ownership allocation in said business entity comprises purchasing said fractional ownership in said first regional operational business entity located in said first region by said at least one of said plurality of regional sports players in at least one of said regional sports organizations which does not exceed said regional sports player's fractional ownership allocation obtainable in said sports organization's fractional ownership allocation in said first regional operational business entity.

50. A method of sports player investment as described in claim 49, further comprising the step of transferring said at least one of said plurality of regional sports players in at least one of said plurality of regional sports organizations having said fractional ownership in said first regional operational business entity from said first region to said second region in which no regional operational business entity exists.

51. A method of sports player investment as described in claim 50, further comprising the step of transferring said plurality of regional preferred shares representing said fractional ownership in said first regional operational business entity of said at least one of said plurality of regional players to said national business entity.

52. A method of sports player investment as described in claim 51, further comprising the step of exchanging said plurality of regional preferred shares representing said fractional ownership in said first regional operational business entity of said at least one of said plurality of regional sports players for an equivalent amount of said plurality of national preferred shares in said national business entity.

53. A method of sports player investment as described in claim 52, further comprising the step of forming said second regional operational business entity in said second region in which no regional operation business entity exists.

54. A method of sports player investment as described in claim 53, further comprising the step of paying a national preferred share basis amount in said plurality of national preferred shares in said national holding business entity to purchase said plurality of regional preferred shares in said second regional holding business entity formed in said second region in which no regional operating business entity exists.

55. A method of sports player investment as described in claim 54, further comprising the step of issuing said plurality of regional preferred shares in said second regional operating business entity formed in said second region to said at least one of said plurality of regional sports players transferred to said second region.

56. A method of sports player investment as described in claim 55, further comprising the step of transferring said at least one of said plurality of regional sports players of said at least one of said plurality of regional sports organizations from said second region in which no said regional operating business entity exists to said first region having said first regional operating business entity located.

57. A method of sports player investment as described in claim 56, further comprising the step of purchasing said fractional ownership in said first regional operational business entity located in said first region by said at least one of said plurality of regional sports players in at least one of said regional sports organizations which does not exceed said sports player's fractional ownership allocation obtainable in said sports organization's fractional ownership allocation in said first regional operational business entity.

58-70. (canceled)
